(19) United States
(12) Patent Application Publication
(10) Pub. No.: US 2002/0196294 A1
(43) Pub. Date: Dec. 26, 2002

(54) Calendar screensaver for a computer display

(76) Inventor: Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/893,167

(22) Filed: Jun. 26, 2001

(51) Int. Cl. G06F 3/14

(52) U.S. Cl. 345/867

(57) ABSTRACT

A calendar screensaver is displayed on a computer device's monitor. The process accesses the original schedule from the computer memory. The schedule, and any accompanying message, is displayed on the monitor as a screensaver while the computer device is inactive mode. If someone tries to access the calendar screensaver in order to schedule time with the workstation's owner, they have access only to the schedule and not to other computer device functions. The updated schedule can then be transmitted to the workstation's owner.

### BACKGROUND OF THE INVENTION

Due to meetings, personal schedules, and work related demands, it can sometimes be difficult for managers to track their employees or for coworkers to get in touch with their colleagues. For example, a salesperson that travels extensively may spend the majority of their time on the road and have random hours in the office.

Additionally, tracking the schedules of people who telecommute can be a difficult task. Some telecommuters have random office hours, depending on meetings and other factors.

In order for someone to inform others of their schedule typically requires one to print out the schedule from the schedule program or write out the schedule by hand and post it for everyone to view. The schedule may be posted on an office door or a cubicle wall. Such a process, however, makes it difficult for colleagues to schedule time with that individual without leaving notes or trading emails. The problem with the notes and emails is that the individual may not have access to these until returning to the office. By that time, the reason the coworker required time with the individual may have passed.

Another problem with the current work calendar and scheduling system is it is difficult for the individual to update. Typically, the person must return to the office and change the schedule then repost it for everyone to view. There is a resulting need for a process for displaying and updating an individual's schedule, thus allowing easier access to that person.

### SUMMARY OF THE INVENTION

The present invention encompasses a calendar screensaver process for a computer. The process first accesses a schedule from the computer's memory. This schedule is then displayed on the computer screen as a screensaving program while the computer device is inactive.

In the preferred embodiment, the schedule is accessible by other individuals wishing to schedule a meeting or other time with the schedule's owner. The individuals have access to the schedule but are excluded from accessing any other functions of the computer while the screensaver process is active.

The screensaver process also enables the user to update his schedule from a remote location, transmit messages for display, and received updated schedules from the computer.

### BRIEF DESCRIPTION OF THE DRAWINGS

FIG. 1 shows a flowchart of a schedule update process of the present invention.

FIG. 2 shows a flowchart of a calendar screensaver process of the present invention.

FIG. 3 shows an example of a computer display in accordance with the calendar screensaver process of the present invention.

FIG. 4 shows a block diagram of a typical computer device used to run the processes of the present invention.

### DETAILED DESCRIPTION OF THE PREFERRED EMBODIMENT

The scheduling process of the present invention provides everyone easy access to an individual's schedule while denying total access to both the computer and the individual's personal schedule. This is accomplished by implementing the scheduling process as a calendar screensaver that is presented on the individual's computer screen when the individual is not present.

Screensaver programs are used on computers to prevent permanent damage to a computer screen while the computer is in an inactive mode, such as when the hard disk drive has not been accessed for a time or if no activity keyboard activity has taken place for a time, or when the computer operating system puts the system into a sleep mode, a standby mode or shuts down other components of the computer. The screensaver program is activated after a predetermined time of inactivity or when manually activated.

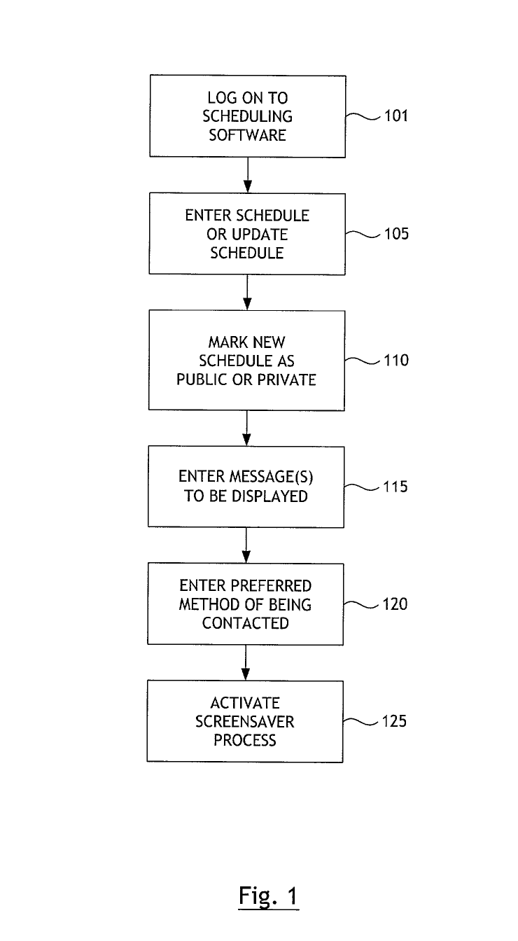

FIG. 1 illustrates a schedule update process of the present invention. This process begins with the user logging-on to the scheduling program (step 101). The scheduling program can be one of many. Examples of such software include OUTLOOK and UP-TO-DATE. In an alternate embodiment, the functions of the scheduling process are built into the calendar screensaver process of the present invention so that a separate program for scheduling is not required.

The user may log on to his computer to update his schedule using various methods. In one embodiment, the user logs on directly while seated at the computer. In another embodiment, the user can log on from a remote location by accessing a network to which the computer is coupled. Using a computer, personal digital assistant, or Web-enabled cellular telephone, the user must first gain access to the network through the use of access codes and/or passwords.

In still another embodiment, the user transmits an email to a predetermined email address (or the address of the computer running the screen saver program) that is read by the computer workstation. The email instructs the calendar screensaver process of the present invention to display the text message of the email on the display or to otherwise update the displayed schedule. For example, if the user is held up due to car trouble, the user enters “CAR TROUBLE, WILL BE IN THE OFFICE AT 11AM” into his personal digital assistant and transmits the email message to his computer.

In one embodiment, the email message has an embedded password. The message could then be used to alter or amend the displayed schedule in addition to or instead of posting a message.

Once into the network, the user either accesses the scheduling program or just transmits a compatible file to the computer that is used by the calendar screensaver process of the present invention to amend his schedule (step 105). The compatible file is one that can be imported either to the scheduling program or to the calendar screensaver process. The user can also mark these inputs as either “private” or “public” (step 110).

Making a schedule item private may prevent access of that schedule item by anyone accessing the user's schedule at his workstation. The user can set the mode of the calendar screensaver process such that only public scheduling is displayed. In this case, that block of time is marked out on the user's workstation computer without explanation as to where the user will be at that time. The user may also set the mode of the process of the present invention such that all items, both private and public, are displayed.

The user, at this time, may input messages to be displayed or different methods by which the user can be contacted (steps 115 and 120). For example, the user may change his schedule then add a note that he can be contacted via cell phone at a certain telephone number. The user may also enter a note that, in his absence, the person to contact is a predetermined manager or other person.

The user can also set this contact information as being time sensitive. For example, if he is going to be in the area only until a predetermined time while waiting for a plane, that time can be programmed into the scheduling such that the note is no longer displayed on the screensaver display after that time has passed. Similarly, the note may be displayed only after a certain time such as when the plane lands and the user is again able to be contacted on the ground in the new location.

The user may enter his preferred way of being contacted as a matrix of time and reason for contact (emergency or normal business). For example, the user could have a column for an emergency contact method as the telephone from 8:00 AM to 12:00 PM then pager after 12:00 PM. The next column could be for normal business contact and list his pager for contact from 8:00 AM until 5:00 PM then e-mail is listed after that.

Once the user has entered the new scheduling information and/or messages, the calendar screensaver process of the present invention is activated (step 125). This is accomplished by either starting the process while seated at the workstation or remotely through the network remote access.

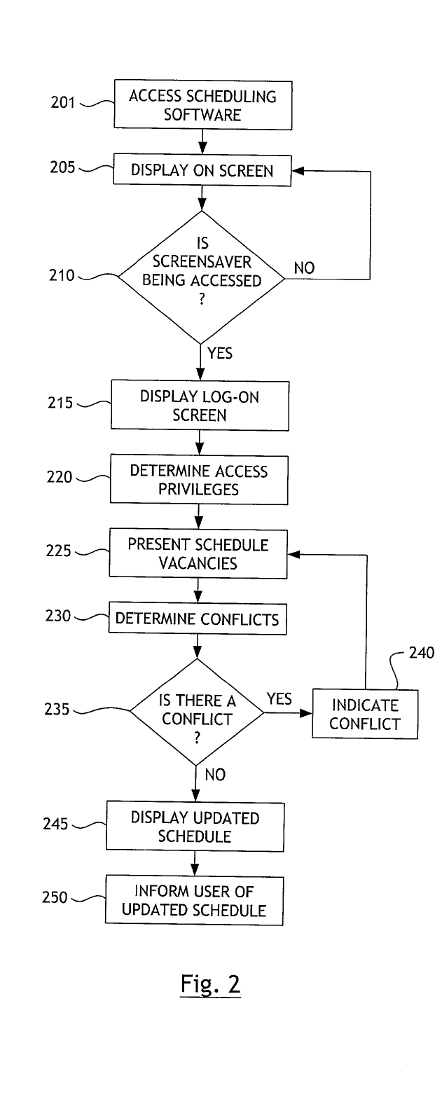

FIG. 2 illustrates a flowchart of the calendar screensaver process of the present invention. The process first accesses the scheduling program to obtain the user's schedule (step 201). This assumes that the scheduling functions are separate from the calendar screensaver process.

The computer's screen is then blanked and the schedule is displayed on the screen (step 205). The process of blanking the screen is well known in the art and is not discussed further.

In one embodiment, in order to prevent burning the image into a cathode ray tube's phosphor, the screen is kept blank until an input of some type is entered. Such an input can be a key being depressed, a sound being entered into the computer's microphone, or even a motion sensor detecting movement in the office or cubicle.

The computer's processor constantly polls the inputs to determine if the screensaver process is being accessed (step 210). If not, the process continues to display the schedule (step 205). If the processor detects an input (step 210), the calendar screensaver process, in one embodiment, displays a log-on screen (step 215). The log-on screen allows only predetermined individuals to access the user's schedule. If the user desires everyone to have access to the schedule, this log-on screen is not displayed.

In another embodiment, the user may display the schedule to anyone presenting an input to the computer but may limit access to changing the schedule to predetermined individuals (step 220). In such an embodiment, the log-on is required to limit the schedule change access to only those individuals having the proper log-on password. This log-on process, in one embodiment, tracks who is accessing and the time of access attempt.

In yet another embodiment, the level of access to the schedule may depend on the individual's access code. For example, the user may desire that only his boss and coworkers within his department have access to scheduling meetings with the user. In this case, those individuals are given a predetermined password that allows them this level of access to the schedule. Other individuals will have a different password that allows them only to view the schedule.

When the access has been determined, the individual desiring access to the schedule is presented with the user's schedule showing the vacancies in the schedule (step 225). This may be accomplished, in one embodiment, as showing only those blocks of the user's schedule that are free to be scheduled by the accessing individual. Another embodiment displays the entire schedule and allows the accessing individual to click on those time blocks that are free in order to attempt to schedule time with the user.

Once the accessing individual has entered the desired time and reason for meeting into the user's schedule, the process performs a conflict check (step 230) to verify that the entered time block is free. For example, the accessing individual may have entered a meeting that runs over into an already scheduled block of time. If a conflict is found (step 235), an error message is displayed to indicate the conflict (step 240) and the accessing individual is given another chance to schedule.

If no schedule conflicts are found (step 235), the new schedule is displayed (step 245) on the user's display. The displayed schedule now includes not only the previous schedule for the user but the newly scheduled meeting set-up by the accessing individual.

The updated (i.e., the updatable) schedule is then transmitted to the user in some fashion (step 250). This can be accomplished by an update mode set by the user. For example, the user may have instructed the update function to inform the user by transmitting an email to a predetermined email address that the user can download using a text-enabled cellular telephone. The computer workstation may also telephone the user's pager and transmitting thereto via the paging system a text message or a code indicating that the schedule has been changed and the user needs to log-on to the network to check the new schedule.

A visitor to the user may desire to leave an electronic message to be displayed for the user. This message could be automatically time/date stamped and either presented on the screen as part of the screensaver or posted to the user upon his return. In another embodiment, the message is sent to the user in a manner that is substantially similar to the transmission of the update function described above.

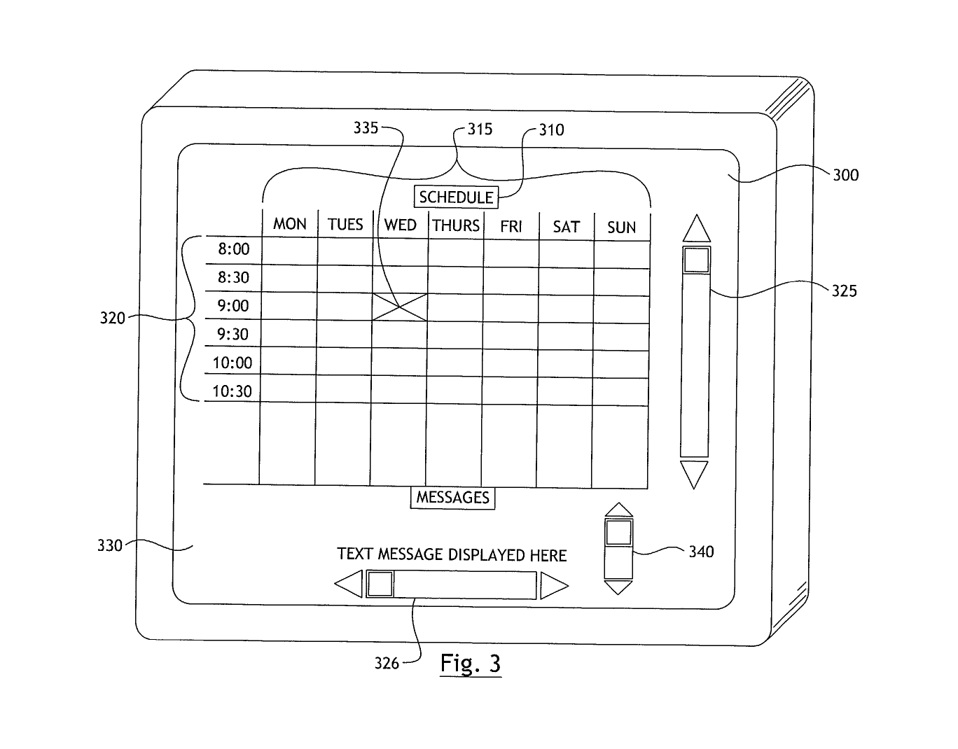

FIG. 3 illustrates one embodiment of a calendar display in accordance with the calendar screensaver process of the present invention. The computer display (300) is a typical display that is well known in the art. Typical embodiments include: cathode ray tubes, liquid crystal displays, or gas plasma displays. The present invention is not limited to any one type of computer display.

The user's schedule (310) is displayed with the day/date (315) along the upper portion and the time of day (320) along the side. If the entire schedule cannot be shown at once, a scroll bar (325) is located along one side to allow individuals to move the time up and down to access the desired time. Another embodiment switches the locations of the day/date and the time. An additional scroll bar (326) could be added to move the days, weeks, or months forward and backward.

In order to distinguish between time blocks that are available and those time blocks that are not available, an “X” may appear across those blocks that are not available (335). In another embodiment, the “X” may be replaced by a text message stating why that block of time is not available as well as the location of the individual (e.g., staff meeting, RM302). In still another embodiment, the individual that is accessing the schedule may position the cursor over the block and the reason the block is not available appears somewhere on the screen. This embodiment is useful to keep the size of the schedule to a minimum for display.

At the bottom of the screen (300) is the message section (330). This section allows the user to display the text messages as described above. This section (330) may also have a scroll bar along one side (340) in case the message is too large for that part of the screen.

The screen illustrated in FIG. 3 is one possible embodiment. The calendar screensaver process of the present invention is not limited to any one format for displaying the scheduling and/or message information.

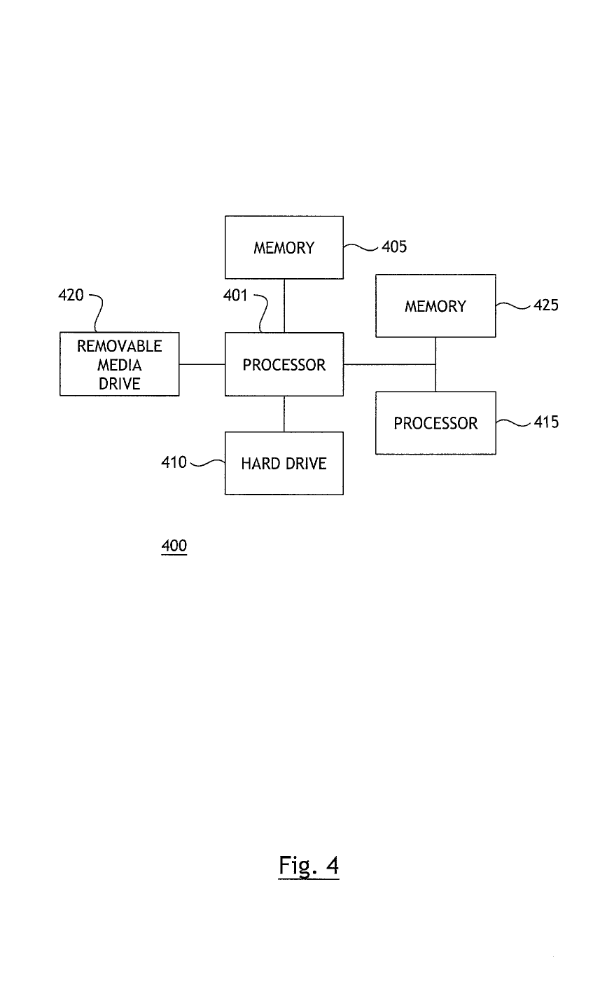

FIG. 4 illustrates a block diagram of a computer (400) that runs the calendar screensaver process of the present invention. This computer is comprised of a processor (401) that controls the computer. This processor (401) can be any one of various processors such as a PENTIUM or POWERPC G3/G4 that run various operating systems such as WINDOWS 2000 and MACINTOSH OS 9.

The memory (405) includes both random access memory (RAM) for temporary storage of data by the processor while running software programs and read only memory (ROM) for permanently storing data used by the processor when it boots up.

A hard drive (410) or other non-volatile storage medium is used to permanently store and provide access to data as well as programs that the computer executes including screen saver programs and associated data such as schedules that are displayed by the screen saver program. Programs and data (as well as schedule data) can also be stored in, and accessed from, the computer memory 405 that includes random access memory (RAM) read only memory (ROM) and electrically erasable programmable read only memory (EEPROM). The stored data includes programs that are loaded onto the computer such as the calendar screensaver process of the present invention as well as stored information of a person's schedule.

The computer operator uses a keyboard (415) to enter data. The keyboard may be a typical QWERTY-style keyboard or a touchscreen display where the data entry is performed by touching a “softkey” with a stylus or finger. The touchscreen display may also be used for character recognition.

A removable disk drive (420) incorporates removable memory media, such as floppy disks, for archival storage of data or to make the data from the computer transportable to other computers. Fixed disk drives, tape and semiconductor memory (well known devices that include RAM, ROM, EEPROM) can also provide storage for data and programs. For example, a computer program may be loaded onto the computer hard drive (410) via the floppy disk drive (420).

The processor is responsible for and performs the function of accessing the original, updatable schedule from memory as well as providing for additional schedule inputs to create and amended schedule while locking out other functions. The processor is also responsible for the function of executing the calendar screensaver process of the present invention from the hard drive (410) and loading it into the memory (405). Once in memory (405), the processor performs the coded instructions as required by the program.

A display (425) is coupled to the processor to display the appropriate output data of the various programs run by the processor (401). As discussed above, the display (425) may be a CRT, LCD, gas plasma, or any other type of display.

The computer illustrated in FIG. 4 is only one embodiment possible for use with the present invention. Not all of the blocks illustrated in FIG. 4 are required for proper operation of the process of the present invention. Other types of computers are encompassed by the present invention including laptop computers and personal digital assistants.

In the preferred embodiment of the calendar screensaver process of the present invention, the individuals accessing the user's schedule are blocked from accessing any other functions of the user's computer. This prevents unauthorized tampering of the computer, as well as accidental change to the data, while the user is away.

The calendar screensaver process of the present invention can be both accessed and downloaded over the Internet. The World Wide Web, or a local web, is first accessed and the calendar screensaver process is then downloaded.

In summary, the calendar screensaver process of the present invention provides a computer workstation user with the ability to display his schedule for others to see. This process enables the user to update the schedule from a remote location as well as permitting others to access the schedule for purposes of setting-up meetings with the user.

Numerous modifications and variations of the present invention are possible in light of the above teachings. It is therefore to be understood that within the scope of the appended claims, the invention may be practiced otherwise than as specifically described herein.

What is claimed is:

1. A calendar screensaver method for a computer device comprising memory and a display, the method comprising the steps of:
accessing an updatable schedule from the memory; and
displaying the updatable schedule on the computer display as a screensaving process at least while the computer device is in an inactive mode.

2. The calendar screensaver method of claim 1 wherein the step of accessing comprises accessing a hard drive for the schedule.

3. The calendar screensaver method of claim 1 wherein the step of accessing comprises accessing random access memory.

4. A calendar screensaver method for a computer device comprising memory and a display, the method comprising the steps of:
accessing an original, updatable schedule from the memory;
displaying the original, updatable schedule on the computer display as a screensaving process while the computer device is in an inactive mode; and
if the updatable schedule is accessed while the computer device is in the inactive mode, enabling input access to only the original, updatable schedule, for additional schedule inputs to create an amended schedule, while locking out other computer device functions.

5. The calendar screensaver method of claim 4 wherein the step of enabling access comprises selectively enabling access in response to an input password.

6. The calendar screensaver method of claim 4 and further including the step of determining conflicts between the amended schedule and the original schedule.

7. The calendar screensaver method of claim 4 and further including the step of displaying a message substantially simultaneously with either the original schedule or the amended schedule.

8. The calendar screensaver method of claim 7 and further including the step of remotely updating the message by text of an e-mail received by the computer device.

9. The calendar screensaver method of claim 4 and further including the step of remotely updating the original schedule by text of an e-mail received by the computer device.

10. A calendar screensaver method for a computer device comprising memory and a display, the method comprising the steps of:
accessing an original, updatable schedule from the memory;
displaying the original, updatable schedule on the computer display as a screensaving process while the computer device is in an inactive mode;
enabling remote input access to the original, updatable schedule, for additional schedule inputs to create an amended schedule; and
displaying the amended schedule on the computer display as the screensaver process.

11. A calendar screensaver method for a computer device comprising memory and a display, the method comprising the steps of:
accessing an original, updatable schedule, of a schedule user, from the memory;
displaying the original, updatable schedule on the computer display as a screensaving process while the computer device is in an inactive mode;
if the updatable schedule is accessed while the computer device is in the inactive mode, determining access privileges of an accessor;
in response to the access privileges, enabling input access to only appropriate portions of the original, updatable schedule, for additional schedule inputs to create an amended schedule, while locking out other computer device functions;
determining if a conflict exists between the amended schedule and the original schedule; and
informing the schedule user of the amended schedule.

12. The calendar screensaver method of claim 11 wherein the step of informing comprises transmitting an email comprising the amended schedule.

13. The calendar screensaver method of claim 11 wherein the step of informing comprises transmitting a wireless, text-enabled telephone compatible message to the wireless telephone.

14. The calendar screensaver method of claim 11 wherein the step of informing comprises transmitting a pager message to the schedule user.

15. The calendar screensaver method of claim 11 and further including the step of displaying a conflict error message if the conflict exists between the amended schedule and the original schedule.

16. A method for downloading a calendar screensaver process over the Internet, the method comprising the steps of:
accessing a predetermined World Wide Web site; and
downloading the calendar screensaver process that comprises the steps of:
accessing an original, updatable schedule from the memory;
displaying the original, updatable schedule on the computer display as a screensaving process while the computer device is in an inactive mode; and
if the updatable schedule is accessed while the computer device is in the inactive mode, enabling input access to only the original, updatable schedule, for additional schedule inputs to create an amended schedule, while locking out other computer device functions.

17. A computer readable storage media comprising:
a program for a calendar screensaver method comprising the steps of:
accessing an original, updatable schedule from the memory;
displaying the original, updatable schedule on the computer display as a screensaving process while the computer device is in an inactive mode; and
if the updatable schedule is accessed while the computer device is in the inactive mode, enabling input access to only the original, updatable schedule, for additional schedule inputs to create an amended schedule, while locking out other computer device functions.

18. A computer device comprising:
memory that stores information generated by the processor;
means for accessing an original, updatable schedule from the memory;
a display that displays the original, updatable schedule as a screensaving process while the computer device is in an inactive mode; and
means for enabling input access to only the original, updatable schedule, for additional schedule inputs to create an amended schedule, while locking out other computer device functions.

19. A calendar screensaver method for a computer device comprising memory and a display, the method comprising the steps of:
accessing an original, updatable schedule from the memory;
displaying the original, updatable schedule on the computer display as a screensaving process while the computer device is in an inactive mode;
displaying a message substantially simultaneously with the original, updatable schedule; and
if the updatable schedule is accessed while the computer device is in the inactive mode, enabling input access to only the original, updatable schedule, for additional schedule inputs to create an amended schedule, while locking out other computer device functions.

20. The calendar screensaver method of claim 19 and further including the step of remotely updating the original schedule over a network.
